(19) United States
(12) Patent Application Publication
(10) Pub. No.: US 2025/0296024 A1
(43) Pub. Date: Sep. 25, 2025

(54) FILTER SYSTEM AND FILTER ELEMENT FOR A FLUID

(71) Applicant: MANN+HUMMEL GmbH, Ludwigsburg (DE)

(72) Inventors: Frank PASSON, Loiching (DE); Andrea HAGEN, Markgröningen (DE); Christian VOGT, Ludwigsburg (DE); Jochen LINHART, Schwaikheim (DE); Robert KUSEBAUCH, Landau (DE); Emrullah ATILGAN, Bad Berneck (DE); Michael HATZELMANN, Wertheim (DE); Jörg SCHÖMMEL, Bretzfeld-Bitzfeld (DE); Melanie MORENO LINARES, Ludwigsburg (DE)

(21) Appl. No.: 19/074,997

(22) Filed: Mar. 10, 2025

(30) Foreign Application Priority Data
Mar. 25, 2024 (DE) 102024108417.0

(51) Int. Cl. B01D 46/00

(52) U.S. Cl. CPC B01D 46/0005; B01D 2201/0415; B01D 2201/4046

(57) ABSTRACT

A filter system for fluid has a housing with first and second fluid connectors and first and second housing parts sequentially arranged along a longitudinal axis and connected to each other. A filter element with a filter medium body and a central pipe arranged inside is arranged in the housing. The second housing part has a connector socket connected to the second fluid connector. The filter element has first and second end discs at axially opposed end faces. The central pipe adjoins a central opening of the second end disc. A positioning element is axially slidable inside the central pipe. With the filter element mounted as intended, the second end disc is arranged at the connector socket of the second housing part. The filter element is rotationally aligned by the positioning element interacting with a counter element of the connector socket. A filter element for the filter system is provided.

### CROSS-REFERENCE TO RELATED APPLICATIONS

This application claims the benefit of German Application No. 10 2024 108 417.0 filed on Mar. 25, 2024, the entire contents of which is incorporated herein by reference.

### BACKGROUND

The invention concerns a filter system for a fluid, for example oil or fuel or cooling agent, as well as a filter element for a filter system.

US 2014/0366494 A1 discloses a liquid filter system with a housing, a removable lid, and an exchangeable filter with a filter body having two end discs. The filter is pushed onto a housing pipe and a locking ring is guided on the housing pipe and pretensioned in a push-out direction. The locking ring is locked by a locking device in a pushed-out position. An unlocking device guided by the filter unlocks the locking action upon pushing the filter onto the housing pipe and enables insertion of the locking ring and of the filter. Upon insertion of the filter into the housing, a seal at one end disk or at the locking ring interacts with a housing seal surface in order to separate an untreated filter side from a clean side. When the locking ring is pushed out and the filter contacts the locking ring, the seal is kept away from the seal surface of the housing.

WO 2018/108802 A1 describes a positioning device with a positioning guide element for positioning a first component relative to a second component to be connected thereto in a circumferential direction, wherein, upon connecting the two components, the positioning guide element interacts with a positioning guide path at the second component for positioning. The positioning guide element is arranged at a seal which is connected, fixed against rotation or connectable so as to be fixed against rotation, to the first component.

### SUMMARY

It is an object of the invention to provide an easily mountable filter system for a fluid, for example oil or fuel or cooling agent.

A further object of the invention is to provide an easily mountable filter element for such a filter system.

The aforementioned object is solved according to an aspect of the invention by a filter system for a fluid, for example oil or fuel or cooling agent, comprising a housing with a first fluid connector and a second fluid connector, and further comprising a filter element arranged in the housing, wherein the housing comprises at least two housing parts which, in a direction of a longitudinal axis, are sequentially arranged and connected to each other, wherein the second housing part comprises an inwardly oriented central connector socket which is connected in fluid communication to the second fluid connector, wherein the filter element comprises a filter medium body with a central tube arranged in the interior of the filter medium body, wherein the filter medium body comprises a first end disc at a first end face, and comprises a second end disc with a central opening at a second end face positioned axially opposite the first end face, wherein the central pipe adjoins the central opening, wherein in the interior of the central pipe an axially slidable positioning element is arranged, wherein, when the filter element is arranged as intended in the housing, the second end disc with the central opening is arranged at the connector socket, wherein the filter element is aligned rotationally by means of the positioning element interacting with a counter element arranged at the connector socket.

According to a further aspect of the invention, the further object is solved by a filter element for a filter system for a fluid, for example oil or fuel or coolant agent, at least comprising a filter medium body with a central pipe arranged in the interior of the filter medium body, wherein the filter medium body comprises a first end disc at a first end face and comprises a second end disc with a central opening at a second end face positioned axially opposite the first end face, wherein the central pipe adjoins the central opening, wherein an axially slidable positioning element is arranged in the interior of the central pipe, wherein the positioning element is configured for interaction with a counter element arranged at a central connector socket upon installation of the filter element in a housing of the filter system.

Due to the positioning element in the interior of the central pipe, a rotational alignment of the filter element is possible, whereby the filter element remains axially slidable due to the axial slidability of the positioning element on the central connector socket. Thus, for example, an immersion of a pin into an axially oriented opening for closing an outwardly oriented fluid outlet bore is possible.

Embodiments and advantages of the invention result from the following description, and the accompanying drawings.

According to an aspect of the invention, a filter system for a fluid, for example oil or fuel or cooling agent, is proposed, comprising a housing with a first fluid connector and a second fluid connector and further comprising a filter element arranged in the housing. The housing comprises at least two housing parts which, in a direction of a longitudinal axis, are sequentially arranged and connected to each other, wherein the second housing part comprises an inwardly oriented central connector socket which is connected in fluid communication to the second fluid connector. The filter element comprises a filter medium body with a central pipe arranged in the interior of the filter medium body, wherein the filter medium body comprises a first end disc at a first end face and comprises a second end disc with a central opening at a second end face which is positioned axially opposite the first end face, wherein the central pipe adjoins the central opening. In the interior of the central pipe, an axially slidable positioning element is arranged. When the filter element is arranged as intended in the housing, the second end disc with the central opening is arranged at the central connector socket. In this context, the filter element is rotationally aligned by means of the positioning element interacting with a counter element arranged at the central connector socket.

The filter system for a fluid may be used for filtering oil or fuel or cooling agent, for example, of an internal combustion engine or of a gear system or for filtering cooling agent of an electrical drive system, for example, an E-machine or a battery.

The first end disc may be of a closed configuration or comprise a central opening which may interact with a receiving element arranged at the first housing part. In this way, an axial guiding action of the filter element in the first housing part is possible. As an alternative, the filter element may also be fixed in the first housing part, for example, by hooks.

The fluid may flow through the first fluid connector into the housing and may flow through the filter element arranged therein in radial direction from the exterior to the interior and may be filtered thereby. Subsequently, the fluid may flow out of the housing through the second fluid connector. In an alternative embodiment, it is possible that the fluid flows through the second fluid connector into the housing, flows through the filter element from the interior to the exterior, and flows out of the housing through the first fluid connector.

The filter element of the proposed filter system comprises an axially movable positioning element with a contour, for example, in the form of an incline or slant inclined at least in sections in relation to the longitudinal axis, wherein the positioning element is fixed, precisely positioned rotationally about the longitudinal axis, in the central pipe of a filter element. The positioning element orients itself at the second fluid connector provided at the housing and aligns the filter element in such a way that a pin, which is axially oriented and is mounted at the second end disc of the filter element, is precisely aligned above a fluid passage bore, for example a fluid drainage bore, and closes the latter upon closing the housing.

The rotational alignment of the filter element is realized in this context by the contour, which is arranged at the positioning element and inclined at least in sections in relation to the longitudinal axis, and a counter contour, which is arranged at a counter element of the central connector socket of the housing, the contour and the counter contour being oriented in parallel to each other in order to determine unequivocally the position of the filter element and of the pin in relation to the housing of the filter system.

Contour and counter contour may be, for example, two corresponding free form surfaces which may be of a planar configuration.

Upon rotational movement of the first housing part in which the filter element is first mounted, the filter element rotates about the longitudinal axis until the contour and counter contour have contact and are parallel. Then the pin is correctly positioned at the second housing part above the fluid drainage bore in the housing.

In this manner, the filter element, when being mounted in the two housing parts, may be simply and safely aligned such that the fluid drainage bore is closed seal-tightly by the pin when the filter element is inserted. Upon removal of the filter element from the second housing part, the raw fluid which remains in the second housing part may drain through the fluid drainage bore.

According to an embodiment of the filter system, an axially inwardly oriented circumferentially extending rim of the counter element may comprise a counter contour which at least in sections is slanted in relation to the longitudinal axis and which is configured so as to correspond to a contour of the positioning element, wherein the contour and counter contour are resting on each other in the direction of the longitudinal axis when the filter element is mounted as intended in the housing. In this context, the rim of the counter element provides an action surface for interaction of the positioning element of the filter element and the counter element of the connector socket of the housing and comprises expediently a counter contour corresponding to the contour of the positioning element. In this manner, the filter element may be aligned rotationally such that the fluid drainage bore, when the filter element is inserted, is seal-tightly closed by the pin. Since the positioning element is axially slidable, for example is pretensioned by a spring force, the filter element is also axially clamped in the housing in the rotationally correct alignment.

According to an embodiment of the filter system, the second housing part may comprise an axially outwardly oriented fluid drainage bore which, when the filter element is inserted as intended, may be seal-tightly closed by a pin which is arranged at the second end disc. In this way, the fluid drainage bore may be seal-tightly closed by the pin when the filter element is inserted. Upon removal of the filter element from the second housing part, the raw fluid remaining in the second housing part may drain through the fluid drainage bore.

According to an embodiment of the filter system, the filter element may be supported slidably with the central opening of the second end disc on the central connector socket. In this context, the central opening of the second end disc may comprise a radially inwardly positioned seal, for example a seal lip. In this way, the filter element, upon mounting in the housing, may move in a suitably guided fashion on the central connector socket and may be reliably sealed in relation to the central connector socket in the mounted state.

According to a further aspect of the invention, a filter element for a filter system for a fluid, for example oil or fuel or cooling agent, is proposed, at least comprising a filter medium body with a central pipe arranged in the interior of the filter medium body, wherein the filter medium body comprises a first end disc at a first end face and comprises a second end disc with a central opening at a second end face positioned axially opposite the first end face, wherein the central pipe adjoins the central opening. In the interior of the central pipe, an axially slidable positioning element is arranged. In this context, the positioning element is configured for interaction with a counter element arranged at a connector socket upon installation of the filter element in a housing of the filter system.

The proposed filter element comprises an axially movable positioning element with a contour, for example, in the form of an incline or slant, wherein the positioning element is fixed, precisely positioned about the longitudinal axis, in the central pipe of the filter element. The positioning element orients itself at a second fluid connector provided at the housing and aligns the filter element such that a pin, which is axially oriented and is mounted at an end disc of the filter element at an outlet side, is precisely aligned above the fluid drainage bore and closes the latter upon closing the housing.

The end disc may be of a closed configuration or comprise a central opening which can interact with a receiving element arranged at a first housing part of the filter system.

The rotational alignment of the filter element is realized in this context by a contour arranged at the positioning element and a counter contour arranged at a counter element of the connector socket of the housing, which are aligned parallel to each other in order to determine the position of the filter element and of the pin in relation to the housing of the filter system in an unequivocal manner.

Upon a rotational movement of the first housing part in which the filter element is first mounted, the filter element rotates about the longitudinal axis until the contour and counter contour have contact and are parallel. Then the pin is correctly positioned at the second housing part above the fluid drainage bore in the housing.

In this manner, the filter element when being mounted in the two housing parts may be simply and reliably aligned such that the fluid drainage bore, when the filter element is inserted, is seal-tightly closed by the pin. Upon removal of the filter element from the second housing part, the raw fluid remaining in the second housing part may drain through the fluid drainage bore.

According to an embodiment of the filter element, the positioning element may be arranged in a cage element connected to the central pipe and may be slidable against a spring force of a spring element connected to the cage element. In this context, a rim of the positioning element which is facing away from the cage element may comprise a contour which is formed in a direction of a longitudinal axis and which is embodied corresponding to a counter contour of the counter element. The rim of the positioning element in this context represents an action surface upon interaction of the positioning element of the filter element and the counter element of the connector socket of the housing and comprises expediently a contour which corresponds to the counter contour of the counter element. In this manner, the positioning element may be arranged to be axially slidable with pretension in the central pipe. In this way, by interaction of the contour of the positioning element, which is slanted at least in sections in relation to the longitudinal axis, and of the counter contour of the counter element, the filter element may be aligned rotationally in the desired manner and may be mounted, axially pretensioned, in the housing under the pretension of the spring element.

According to an embodiment of the filter element, the cage element and the central pipe may comprise a locking connection. In this context, the cage element may be configured to catch at a radially inwardly oriented collar of the central pipe. In this way, a simple and reliable mounting of the cage element in the central pipe is provided.

According to an embodiment of the filter element, the positioning element and/or the cage element may comprise axially extending guide elements for axially guiding the positioning element in the cage element. In this manner, the positioning element may be safely and reliably guided upon axial movement in the cage element.

According to an embodiment of the filter element, the end discs may be connected to the central pipe so as to be fixed against rotation. In this way, the central pipe may be inserted in the filter medium body and the end discs may be subsequently fused, for example, by infrared welding, or glued to the central pipe.

According to an embodiment of the filter element, at least one of the two end discs, for example the second end disc, may be inserted into the central pipe and the other one of the end discs, for example the first end disc, may be formed as one piece together with the central pipe. In this way, the central pipe may be connected to the end discs in a simple and inexpensive manner.

According to an embodiment of the filter element, the at least one of the two end discs which is inserted may comprise an axially and/or radially aligned positioning element for rotational alignment of the at least one inserted end disc when being mounted on the central pipe. In this manner, the end disc may be connected in a defined rotational position to the central pipe.

According to an embodiment of the filter element, the second end disc may comprise a pin which is oriented axially away from the central pipe. In this context the pin may comprise a radially outwardly circumferentially extending seal element. The pin, which is axially aligned and is mounted at the end disc of the filter element at the outlet side, may be aligned, by the rotational alignment of the filter element, so as to be precisely positioned above the fluid drainage bore and may close the latter upon closing the housing.

According to an embodiment of the filter element, the positioning element and the cage element may comprise radially extending passages. In this context, the passages may be positioned at least in sections so as to overlap. In this way, a reliable flow of the fluid through the central pipe may be ensured.

### BRIEF DESCRIPTION OF DRAWINGS

Other advantages result from the following description of the drawings. In the drawings, exemplary embodiments of the invention are illustrated. The drawings and the description contain numerous features in combination. A person of skill in the art will consider the features expediently also individually and combine them to expedient further combinations.

FIG. 1 shows a section illustration of a filter system for a fluid, for example oil or fuel or cooling agent, according to an embodiment of the invention.

FIG. 2 shows a section illustration of the housing of the filter system according to FIG. 1.

FIG. 3 shows a section illustration of a filter element according to an embodiment of the invention.

FIG. 4 shows an exploded illustration of the central pipe of the filter element.

FIG. 5 shows a section illustration of the assembled central pipe.

FIG. 6 shows a section illustration of a filter system according to a further embodiment of the invention.

FIG. 7 shows a section illustration of a filter element of the filter system according to a further embodiment of the invention.

FIG. 8 shows an exploded illustration of the central pipe of the filter element according to FIG. 7 with the end discs.

### DETAILED DESCRIPTION

In the drawings, same or same-type components are identified with the same reference characters. The drawing figures show only examples of the invention and are not to be understood as limiting.

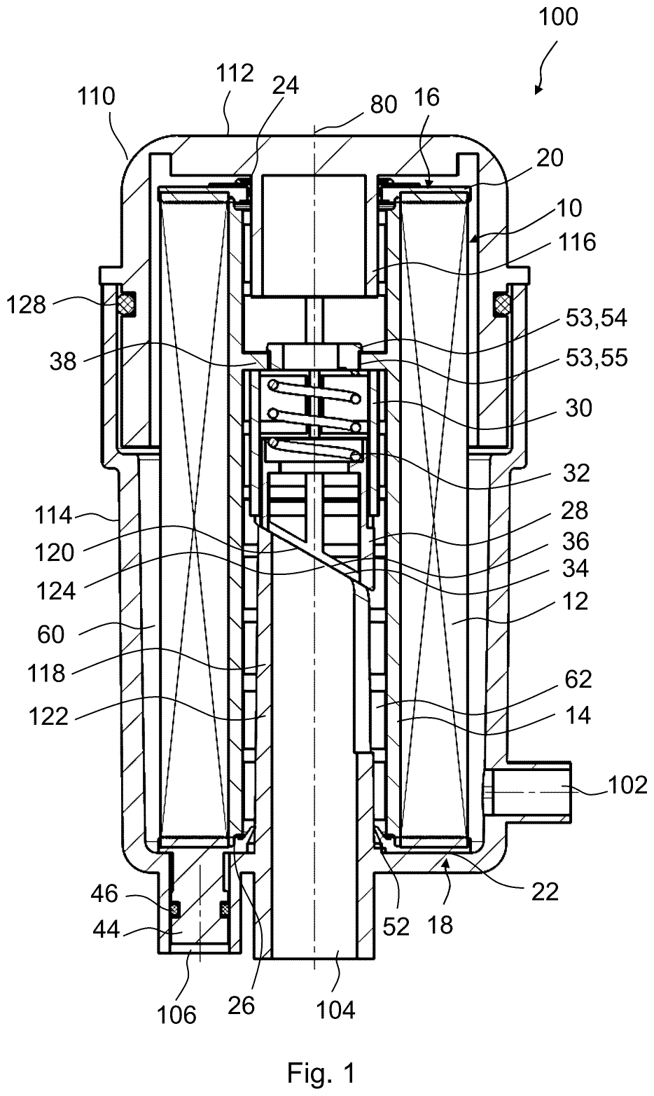

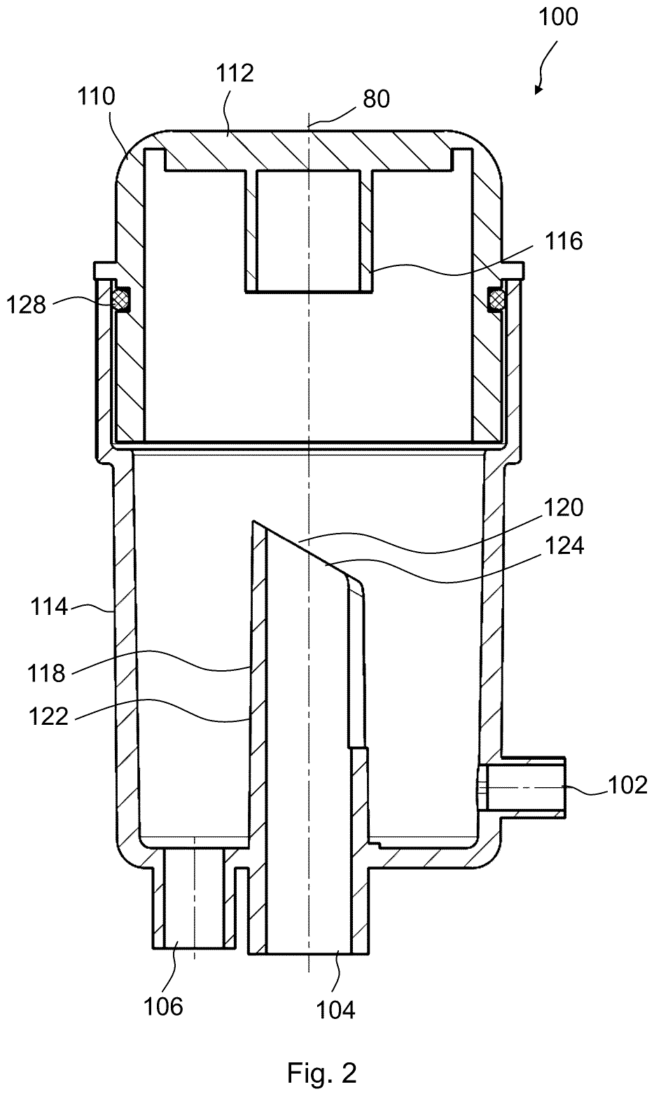

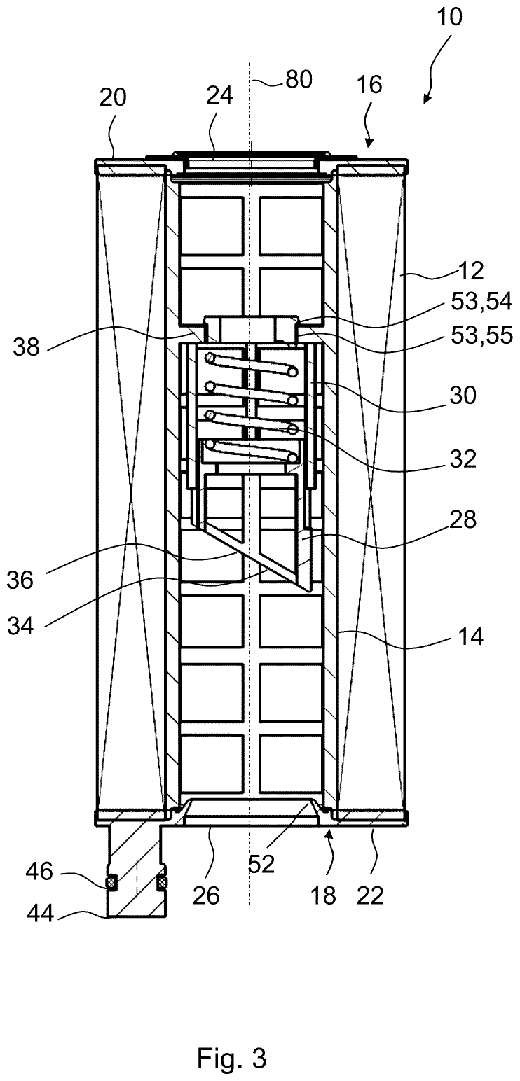

For explaining the invention, FIG. 1 shows a section illustration of a filter system 100 for a fluid, for example oil or fuel or cooling agent, according to an embodiment of the invention. FIG. 2 shows a section illustration of the housing 110 of the filter system 100, while in FIG. 3 a section illustration of the filter element 10 according to an embodiment of the invention is illustrated.

The filter system 100 for a fluid may be used for filtering oil or fuel or cooling agent, for example, of an internal combustion engine or a gear system, or for filtering cooling agent of an electrical drive system, for example, an E-machine or a battery.

The filter system 100 comprises a housing 110 with a first fluid connector 102 and a second fluid connector 104. The filter element 10 is arranged in the housing 110. The fluid may flow through the first fluid connector 102 into the housing 110 into a raw fluid region 60, may pass from a radially outward location through the filter element 10 into a clean fluid region 62 and may flow through an outlet socket 122 and the second fluid connector 104 out of the housing 110 again.

In an alternative embodiment, the fluid may flow also through the second fluid connector 104 into the housing 110, may flow through the filter element 10 radially from the interior to the exterior and, filtered, may flow out again through the first fluid connector 102.

The housing 110 comprises two housing parts 112, 114 which are connected to each other, for example, by screwing. The two housing parts 112, 114 are sealed at the joining location by a circumferentially extending seal element 128, for example, an O-ring, in relation to the environment.

As may be seen in FIG. 2, the first housing part 112 in this embodiment comprises an inwardly oriented receiving element 116 in the form of a pipe socket. The second housing part 114 comprises an inwardly oriented central connector socket 122 which is connected in fluid communication to the second fluid connector 104.

An axially inwardly oriented circumferentially extending rim 120 of a counter element 118 comprises a counter contour 124, which is inclined in relation to a longitudinal axis 80 at least in sections and provides an action surface which is embodied corresponding to a contour 36 of the positioning element 28 (see FIG. 3). Contour 36 and counter contour 124 are resting on each other in a direction of the longitudinal axis 80 when the filter element 10 is mounted as intended in the housing 110.

As best seen in FIG. 3, the filter element 10 comprises a filter medium body 12 with a central pipe 14 arranged in the interior of the filter medium body 12. The filter medium body 12 comprises a first end disc 20 at a first end face 16 and comprises a second end disc 22 with a central opening 26 at a second end face 18 positioned axially opposite the first end face 16. In this embodiment, the first end disc 20 comprises also a central opening 24. The central pipe 14 adjoins in this context both openings 24, 26 and is fixedly connected to both end discs 20, 22. The central pipe 14 may be connected so as to be fixed against rotation to the end discs 20, 22, for example, may be infrared-welded or glued.

In the interior of the central pipe 14, an axially slidable positioning element 28 is arranged. The positioning element 28 is arranged in a cage element 30 connected to the central pipe 14 and is slidable against a spring force of a spring element 32 connected to the cage element 30. A rim 34 of the positioning element 28 facing away from the cage element 30 comprises a slanted contour 36 embodied in a direction of the longitudinal axis 80 as an action surface which is embodied corresponding to the counter contour 124 of the counter element 118.

When the filter element 10 is arranged in the housing 110 as intended, as illustrated in FIG. 1, the first end disc 20 with the central opening 24 is arranged at the receiving element 116 of the first housing part 112 and the second end disc 22 with the central opening 26 at the central connector socket 122.

In this context, the filter element 10 is aligned rotationally by means of the positioning element 28 interacting with the counter element 118 arranged at the central connector socket 122.

The filter element 10 is slidingly supported by the central opening 26 of the second end disc 22 on the central connector socket 122 and may thus be moved in the direction of the longitudinal axis 80 on the central connector socket 122. In this context, the central opening 26 of the second end disc 22 comprises a radially inwardly positioned seal 52, for example a seal lip, with which the filter element 10 is sealed against the central connector socket 122.

The second housing part 114 comprises an axially outwardly oriented fluid drainage bore 106 which, when the filter element 10 is mounted as intended in the desired rotational alignment, is seal-tightly closed by a pin 44 arranged at the second end disc 22. The pin 44 for this purpose is oriented axially away from the central pipe 14. The pin 44 comprises a radially outwardly circumferentially extending seal element 46 so that the fluid drainage bore 106 is reliably seal-tightly closed when the pin 44 is inserted.

When mounting the filter element 10 in the housing 110, the positioning element 28 orients itself at the central connector socket 122 of the housing 110 and aligns the filter element 10 in such a way that the axially oriented pin 44 mounted at the second end disc 22 of the filter element 10 is precisely positionally aligned above the fluid drainage bore 106 and closes the latter upon closing the housing 110.

The rotational alignment of the filter element 10 is realized in this context via the contour 36 arranged at the positioning element 28 and the counter contour 124 arranged at the counter element 118 of the central connector socket 122 of the housing 110, which are aligned parallel to each other in order to determine unequivocally the position of the filter element 10 and of the pin 44 in relation to the housing 110 of the filter system 100.

Upon rotational movement of the first housing part 112 in which the filter element 10 is first mounted, the filter element 10 rotates about the longitudinal axis 80 until the contour 36 and counter contour 124 have contact and are parallel. Then the pin 44 is positioned at the second housing part 114 correctly above the fluid drainage opening 106 in the housing 110.

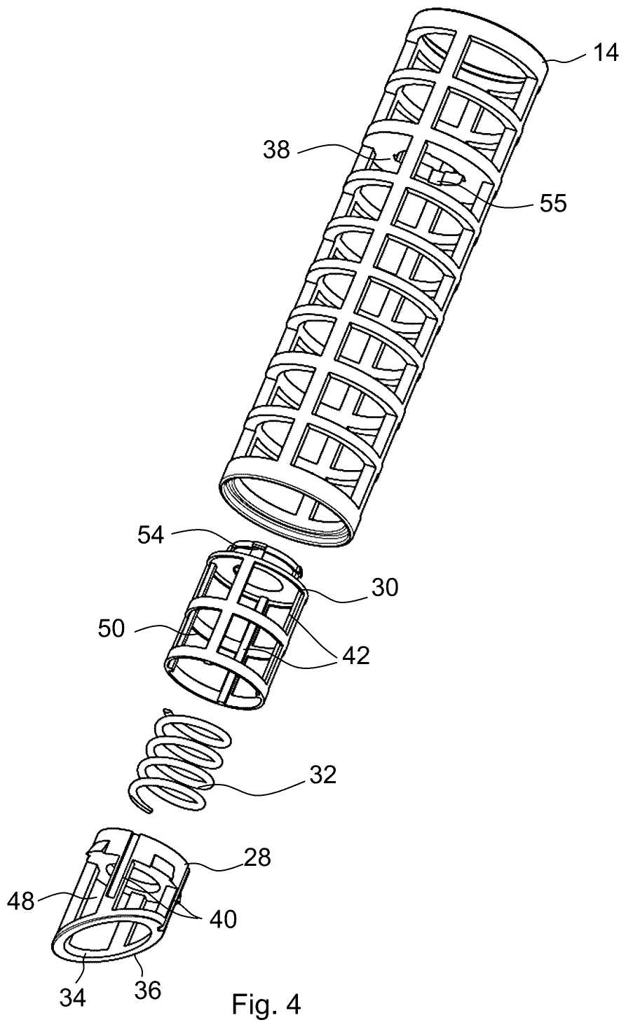

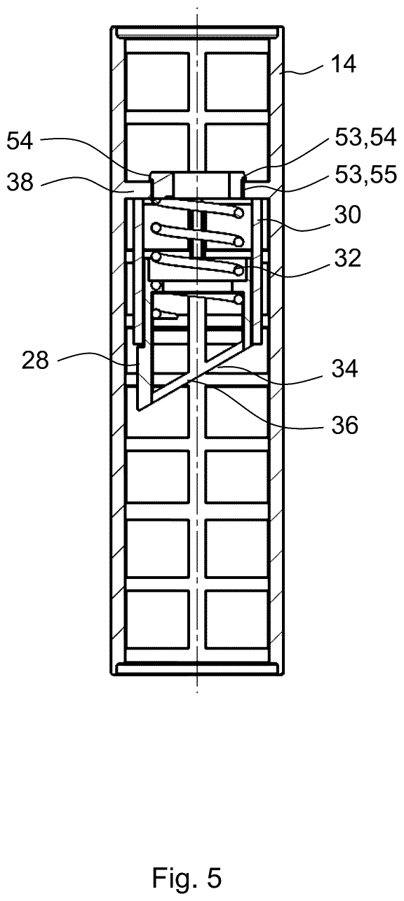

FIG. 4 shows an exploded illustration of the central pipe 14 of the filter element 10, while in FIG. 5 a section illustration of the assembled central pipe 14 is illustrated.

Central pipe 14, cage element 30, spring element 32, and positioning element 28 may be individual parts.

The cage element 30 and the central pipe 14 may be connected by a locking connection 53. In this context, the central pipe 14 comprises in the interior a radially inwardly oriented collar 38 with counter locking elements 55 in which the cage element 30 may engage and lock by means of locking elements 54.

In the interior of the cage element 30, a spring element 32 is inserted which pretensions the positioning element 28 inserted into the cage element 30.

Positioning element 28 and cage element 30 comprise axially extending guide elements 40, 42 for axial guiding of the positioning element 28 in the cage element 30. In this context, the guide elements 40 in the positioning element 28, as illustrated, may be formed as grooves while the guide elements 42 of the cage element 30 are embodied as webs which engage the grooves. As an alternative, however, the guide elements 40 of the positioning element 28 may be embodied as webs and the guide elements 42 of the cage element 30 as grooves.

The positioning element 28 and the cage element 30 comprise radially extending passages 48, 50 which at least in sections may overlap each other so that the fluid may flow from the exterior to the interior through the central pipe 14 or, in an alternative embodiment, from the interior to the exterior.

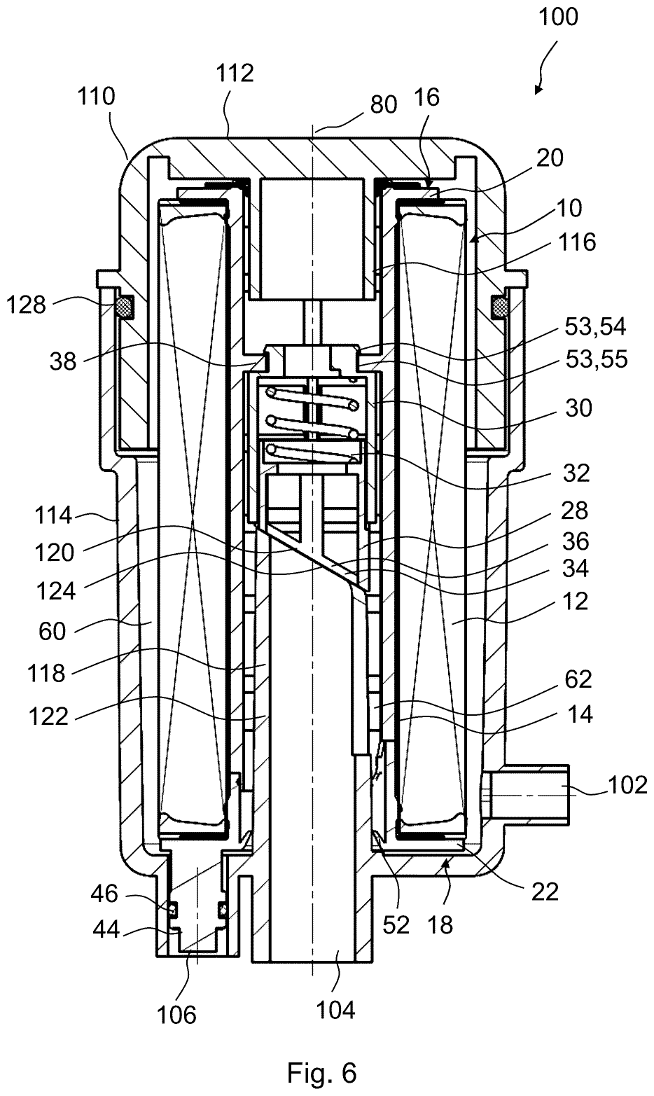

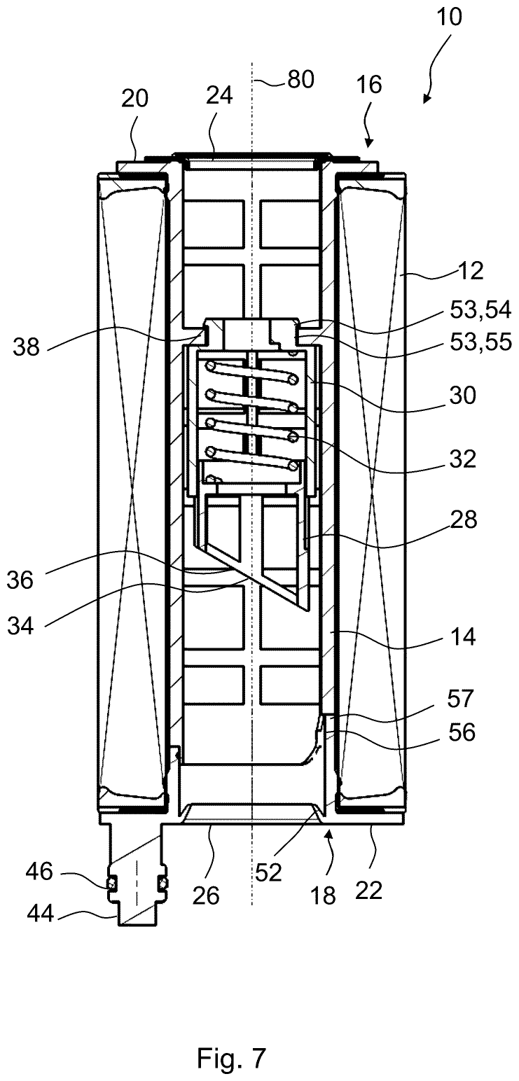

FIG. 6 shows a section illustration of a filter system 100 according to a further embodiment of the invention with a filter element 10 according to a further embodiment. In FIG. 7, a section illustration of the filter element 10 according to a further embodiment of the invention is illustrated.

In this embodiment, at least one of the two end discs 20, 22, namely the second end disc 22, is inserted into the central pipe 14 and the other one of the end discs 20, 22, the first end disc 20, is embodied as one piece together with the central pipe 14.

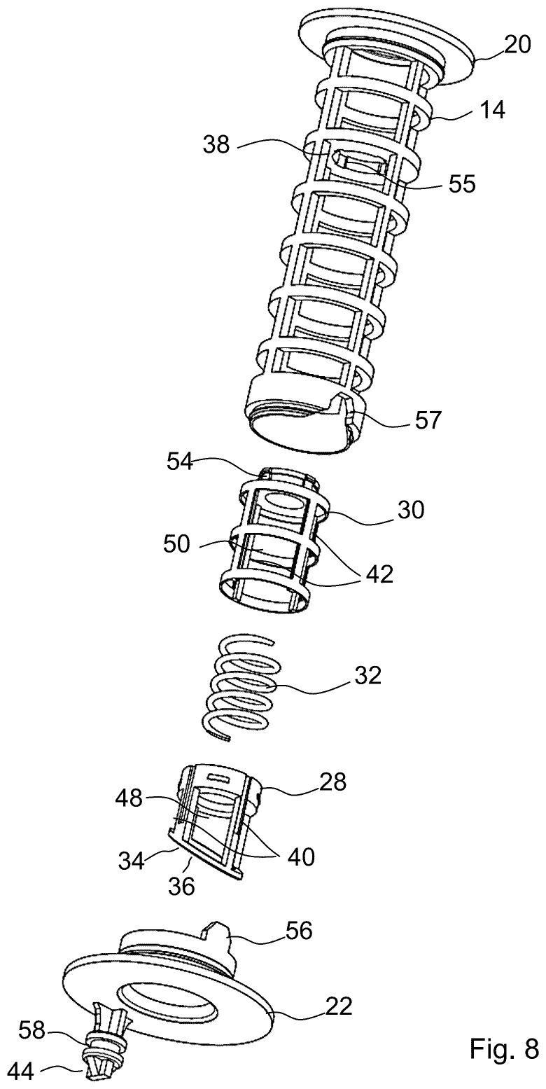

FIG. 8 shows in this respect an exploded illustration of the central pipe 14 of the filter element 10 according to FIG. 7 with the end discs 20, 22.

The first end disc 20 is connected to the upper part of the central pipe 14, while the second end disc 22 may be pushed onto the opposite end of the central pipe 14. For this purpose, the pushed-on end disc 22 comprises an axially oriented positioning element 56 for rotational alignment of the end disc 22 upon mounting on the central pipe 14. The positioning element 56 interacts in this context with a cutout 57 of the central pipe 14. In this way, the position of the end disc 22 relative to the orientation of the central pipe 14 is determined unequivocally.

At the second end disc 22, the pin 44 which is axially oriented away from the central pipe 14 may be seen with a seal groove 58 for attaching the seal element 46.

The configuration, assembly, and action of cage element 30 and positioning element 28 are comparable to the embodiment illustrated in FIGS. 1-5. In order to avoid unnecessary repetitions, reference is had thereto.

### REFERENCE CHARACTERS

10 filter element
12 filter medium body
14 central pipe
16 first end face
18 second end face
20 first end disc
22 second end disc
24 central opening
26 central opening
28 positioning element
30 cage element
32 spring element
34 rim
36 contour
38 collar
40 guide element
42 guide element
44 pin
46 seal element
48 passage
50 passage
52 seal
53 locking connection
54 locking element
55 counter locking element
56 positioning element
57 cutout
58 seal groove
60 raw fluid region
62 clean fluid region
80 longitudinal axis
100 filter system
102 first fluid connector
104 second fluid connector
106 fluid passage bore
110 housing
112 first housing part
114 second housing part
116 receiving element
118 counter element
120 rim—action surface
122 central connector socket
124 counter contour
128 seal element

1. A filter system for a fluid, the filter system comprising:
a housing comprising a first fluid connector and a second fluid connector; and
a filter element arranged in the housing;
wherein the housing comprises at least a first housing part and a second housing part, the first housing part and the second housing part being sequentially arranged in a direction of a longitudinal axis of the housing and connected to each other;
wherein the second housing part comprises an inwardly oriented central connector socket connected in fluid communication to the second fluid connector;
wherein the filter element comprises a filter medium body and a central pipe arranged in an interior of the filter medium body, the filter medium body comprising a first end face and a second end face positioned axially opposite the first end face; and
wherein the filter element comprises a first end disc arranged at the first end face of the filter medium body and a second end disc comprising a central opening, the second end disc being arranged at the second end face of the filter medium body, and the central pipe adjoining the central opening of the second end disc;
a positioning element arranged axially slidably in an interior of the central pipe of the filter element;
wherein, when the filter element is mounted in the housing, the second end disc comprising the central opening is arranged at the central connector socket of the second housing part; and
wherein the filter element is rotationally aligned by the positioning element interacting with a counter element arranged at the central connector socket of the second housing part.

2. The filter system according to claim 1, wherein the counter element comprises an axially inwardly oriented circumferentially extending rim comprising a counter contour, wherein the counter contour is inclined at least in sections in relation to the longitudinal axis of the housing and is embodied corresponding to a contour of the positioning element, and wherein the contour and the counter contour are aligned on each other in the direction of the longitudinal axis of the housing when the filter element is mounted in the housing.

3. The filter system according to claim 1, wherein the second housing part comprises an axially outwardly oriented fluid passage bore and wherein the second end disc comprises a pin, and wherein the fluid passage bore is seal-tightly closed by the pin when the filter element is mounted in the housing.

4. The filter system according to claim 3, wherein the fluid passage bore is a fluid drainage bore.

5. The filter system according to claim 1, wherein the filter element is slidably supported on the central connector socket of the second housing part by the central opening of the second end disc.

6. The filter system according to claim 5, wherein the central opening of the second end disc comprises a radially inwardly positioned seal.

7. A filter element for a filter system for a fluid, the filter element comprising:
a filter medium body comprising a first end face and a second end face positioned axially opposite the first end face;
a central pipe arranged in an interior of the filter medium body;
a first end disc arranged at the first end face of the filter medium body;
a second end disc comprising a central opening, wherein the second end disc is arranged at the second end face of the filter medium body, and wherein the central pipe adjoins the central opening of the second end disc;
a positioning element arranged axially slidably in the interior of the central pipe, wherein the positioning element is configured to interact with a counter element arranged at a central connector socket of a housing of the filter system when the filter element is installed in the housing of the filter system.

8. The filter element according to claim 7, further comprising a cage element connected to the central pipe, wherein the positioning element is arranged in the cage element and is slidable against a spring force of a spring element connected to the cage element, wherein a rim of the positioning element facing away from the cage element comprises a contour which is arranged in a direction of a longitudinal axis of the housing and configured to correspond to a counter contour of the counter element arranged at the central connector socket of the housing.

9. The filter element according to claim 8, wherein the cage element and the central pipe comprise a locking connection.

10. The filter element according to claim 8, wherein the central pipe comprises a radially inwardly oriented collar and the cage element is configured to lock at the radially inwardly oriented collar of the central pipe.

11. The filter element according to claim 8, wherein the positioning element and/or the cage element comprises axially extending guide elements configured to axially guide the positioning element in the cage element.

12. The filter element according to claim 8, wherein the positioning element and the cage element comprise radially extending passages.

13. The filter element according to claim 12, wherein the radially extending passages overlap each other at least in sections.

14. The filter element according to claim 7, wherein the first end disc and the second end disc are non-rotationally connected to the central pipe.

15. The filter element according to claim 7, wherein at least one of the first end disc and the second end disc is inserted into the central pipe and the other one of the first end disc and the second end disc is configured as one piece together with the central pipe.

16. The filter element according to claim 15, wherein the at least one of the first end disc and the second end disc inserted into the central pipe comprises an axially and/or radially oriented positioning element configured to rotationally align the at least one of the first end disc and the second end disc inserted into the central pipe upon mounting on the central pipe.

17. The filter element according to claim 7, wherein the second end disc is inserted into the central pipe and the first end disc is configured as one piece together with the central pipe.

18. The filter element according to claim 7, wherein the second end disc comprises a pin facing axially away from the central pipe.

19. The filter element according to claim 18, wherein the pin comprises a circumferentially extending seal element.
